(19) United States
(12) Patent Application Publication
(10) Pub. No.: US 2006/0279215 A1
(43) Pub. Date: Dec. 14, 2006

(54) Flat fluorescent lamp

(76) Inventors: Jae Doo Yoon, Yangpyung-gun (KR); Chung Soo Kim, Seongnam-si (KR); Do Young Cho, Dongnae-gu (KR); Jong Lee Park, Cheonan-si (KR)

Correspondence Address: FLESHNER & KIM, LLP, P.O. BOX 221200, CHANTILLY, VA, 20153, US

(21) Appl. No.: 11/413,120

(22) Filed: Apr. 28, 2006

(30) Foreign Application Priority Data
Jun. 8, 2005 (KR) 10-2005-0048813

(51) Int. Cl. H01J 17/02; H01J 61/02; H01J 61/00; H01J 17/00

(52) U.S. Cl. 313/611; 313/581; 313/612

(57) ABSTRACT

Provided is a flat fluorescent lamp for a display device, having a plurality of discharge channels provided parallel to each other. The discharge channels have a characteristic structure of alternating the broad channel region with large cross-section area and the narrow channel region with small cross-sectional area along the longitudinal direction of the discharge channel. Thus, it is possible to enhance luminance of and improve discharge efficiency of the flat fluorescent lamp.

### BACKGROUND OF THE INVENTION

1. Field of the Invention

The present invention relates to a flat fluorescent lamp for a display device, and more particularly to, by changing shape of a discharge channel, enhancing luminance of the flat fluorescent lamp and improving discharge efficiency of the flat fluorescent lamp.

2. Description of the Related Art

The display device can be categorized into emissive and non-emissive display devices. Liquid crystal display (LCD) involved in the present invention is a representative example of the non-emissive display device which requires backlight, such as fluorescent lamps, behind the LCD panel to display thereon characters, images, and so forth.

Backlight units can be roughly classified into edge and direct types, based upon the arrangement of the cylindrical fluorescent lamps behind the LCD panel. Recent trend has been toward developing the flat fluorescent lamp to meet demands for the larger-sized display panel and for improvement in production efficiency.

An example of conventional flat fluorescent lamp (FFL) is illustrated in FIGS. 1 and 2. As shown in FIGS. 1 and 2, the lamp 1 comprises an upper substrate 1a and a lower substrate 1b which are coupled and integrated with each other into a flat-shaped body. Discharge channels 2 are formed on the upper substrate 1a and define discharge spaces 3 independent of each other.

The discharge channel 2 is filled with a discharge gas including an inert gas and a small amount of mercury and the inner surface of the discharge channel 2 is coated with a fluorescent material. Electrodes 4, which may be internal electrode or external electrode, are provided at both ends of each of the discharge channels. Ultraviolet rays are generated from the discharge gas by applying an alternating current voltage ranging from several hundred V to several kV to the lamp 1 through the electrode 4. The generated ultraviolet rays excite the fluorescent material to emit visible light.

The flat fluorescent lamp generally has superior luminance uniformity, but has the following disadvantages.

Firstly, enhancement of luminance of the lamp necessarily brings about increase in power consumption and deterioration in discharge efficiency. For example, decrease in a cross-sectional area enhances luminance of the lamp, but deteriorates discharge efficiency.

Secondly, “dark line” occurs due to a non-emissive area existing between discharge channels.

A discharge channel 2a, as shown in FIG. 3, can be bent and extended into the serpentine shape to improve the discharge efficiency or the light-emitting efficiency in the lamp. The serpentine-shaped discharge channel enables Positive Column Region to extend along the discharge channel 2a, thus improving the efficiency of the lamp.

However, the flat fluorescent lamp with serpentine-shaped discharge channels requires corresponding increases in discharge initialization voltage and discharge maintenance voltage as the discharge channel becomes longer, and makes it difficult to maintain the luminance uniformity above the required level.

### BRIEF DESCRIPTION OF THE INVENTION

Therefore, an object of the present invention is to provide a flat fluorescent lamp with enhanced luminance and improved discharge efficiency.

Another object of the present invention is to alleviate or remove “line” arising from a non-emissive area existing between discharge channels.

According to an aspect of the present invention, there is provided a flat fluorescent lamp including an upper substrate, a lower substrate attached to the upper substrate and a plurality of discharge channels provided parallelly to each other on the upper substrate, in which at least one of the plurality of discharge channels has alternating broad and narrow channel regions along the longitudinal direction of the discharge channel. The broad channel region has larger cross-sectional area of the discharge channel (or discharge space), relative to the narrow channel region.

Each of the plurality of discharge channels may have alternating broad and narrow channel regions.

Conventional flat fluorescent lamp have discharge channels, each of which is designed to have the same cross-sectional area along the longitudinal direction of the discharge channel. This is based on the belief that changes in the cross-sectional areas along the longitudinal direction of the discharge channel causes deterioration in luminance or luminance uniformity of the lamp. However, the regular changes in the cross-sectional areas of the discharge channel in the direction of the length of the discharge channel according to the present invention make it possible to enhance the luminance and improve the discharge efficiency.

The luminance of the lamp generally depends on the cross-sectional area of the discharge channel. More specifically, the smaller the cross-sectional area of the discharge channel is, the more enhanced the luminance is, and the larger the cross-sectional area of the discharge channel is, the more decreased the luminance is. Additionally, the smaller the cross-sectional area is, the more increased the power consumption is, and the larger the cross-sectional area is, the more decreased the power consumption is.

For example, in a case where a ratio of the number of the broad channel regions to the number of the narrow channel regions is 50:50 in a lamp, the whole luminance of the lamp (or luminance efficiency) is estimated to be equal to the sum of average luminance (or luminance efficiency) of the broad channel regions and average luminance (or luminance efficiency) of the narrow channel regions. However, the whole luminance of the lamp according to the present invention is greater than the sum of average luminance of the broad channel regions and average luminance of the narrow channel regions. This presumptively results from combined operations of movement of electrons, electric potential values, and the discharge gas in the plasma changing along the length direction of the discharge channel.

The cross-sectional area of the discharge channel in the direction of the length of the discharge channel may be changed by adjusting a height of the discharge channel or a width of the discharge channel or both. The adjustment of the height of the discharge channel is more advantageous in designing the discharge channel and forming the lamp. In this case, the broad channel regions have greater height than the narrow channel regions have greater height than the narrow channel regions.

It is notable that the excessive difference in the cross-sectional area between the broad channel region and the narrow channel region results in the excessive contrast between light and darkness.

There exist a variety of possible ways in arranging the broad and the narrow channel regions between a certain discharge channel and its neighboring discharge channels. The possible ways are described in detail below.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a plane drawing of a conventional flat fluorescent lamp;

FIG. 2 is a cross-sectional view taken along II-II line of FIG. 1;

FIG. 3 is a plane drawing of the conventional flat emissive fluorescent having a serpentine shape;

FIG. 4A is a plane drawing of a flat fluorescent lamp according to a first embodiment of the present invention;

FIG. 4B is an exploded cut away view of a “A” marked portion of FIG. 4A;

FIG. 5 is a cross-sectional view taken along V-V line of FIG. 4A;

FIG. 6 is a cross-sectional view taken along VI-VI line of FIG. 4A;

FIG. 7 is another cross-sectional view taken along V-V line of FIG. 4A;

FIGS. 8 and 9 are variant examples of the flat fluorescent lamp according to a second embodiment of the present invention;

FIG. 10A is a plane drawing of the flat fluorescent lamp according to the second embodiment of the present invention;

FIG. 10B is an exploded cut away view of a “B” marked portion of FIG. 10A; and

FIG. 11 is a plane drawing of the flat fluorescent lamp according to a third embodiment of the present invention.

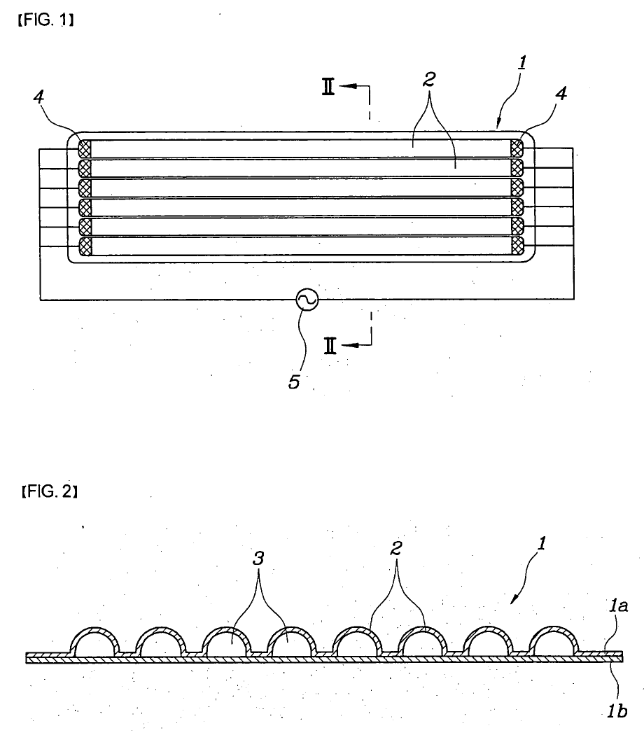

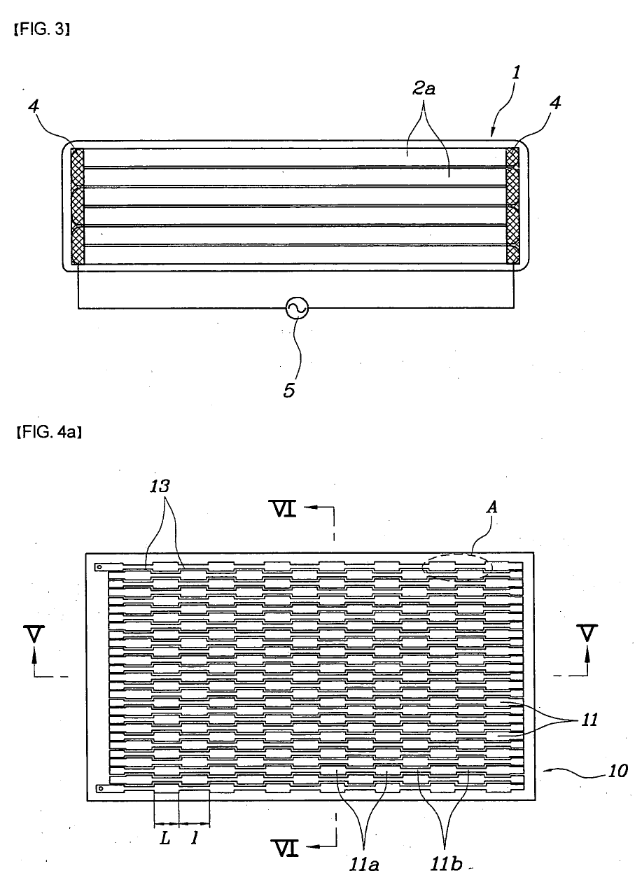

### DETAILED DESCRIPTION OF THE INVENTION

Reference will now be made in detail to the preferred embodiments of the present invention, examples of which are illustrated in the accompanying drawings. The change in the cross-sectional area of the discharge channel is below described in detail, with the emphasis placed on the change in the width of the discharge channel.

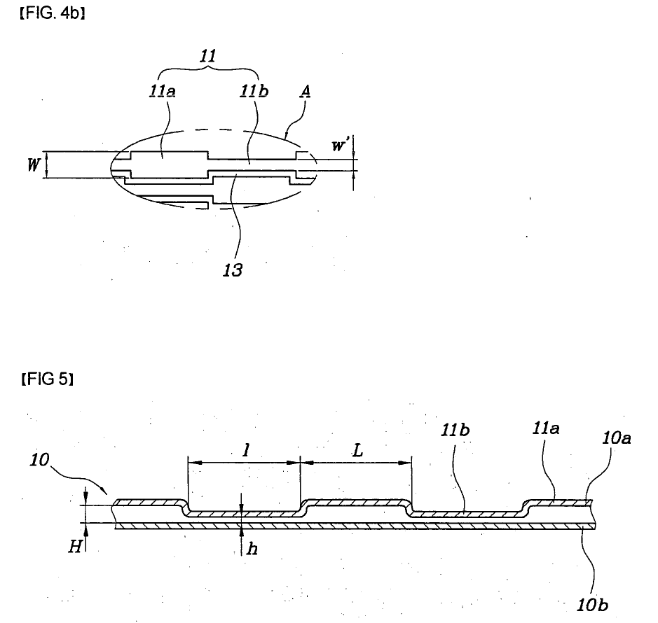

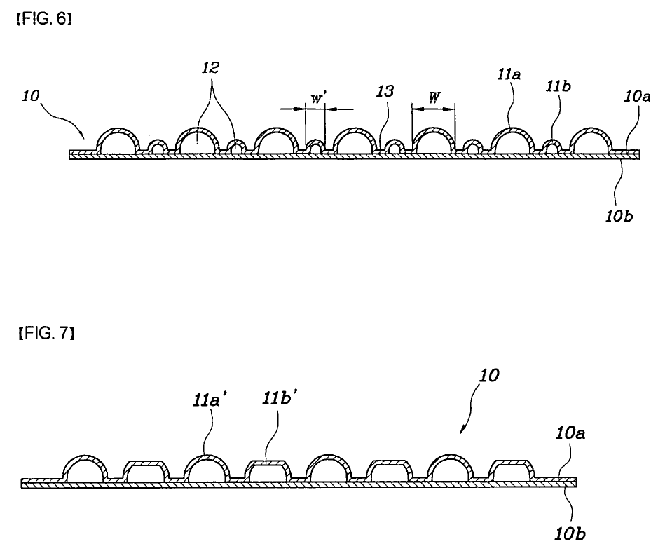

Referring to FIG. 4A to 6, a flat fluorescent lamp according to a first embodiment of the present invention is below described.

A lamp 10 basically includes an assembly of an upper substrate 10a, a lower substrate 11b, and a plurality of discharge channels 11 in parallel with each other. The discharge channels 11 are generally provided on the upper substrate 10a. A plurality of discharge spaces 12, which are defined by the space between the discharge channels 11 of the upper substrate 10a and the lower substrate 10b, are independent of each other. However, the discharges channels 11 may be connected to their neighboring discharge channels through a connection passage for diffusing the discharge gas.

The discharge channel has a characteristic structure of alternating the broad channel region with large cross-section area and the narrow channel region with small cross-sectional area. For example, the width (H) and/or the height (W) of the broad channel region may be greater than those (h) and/or (w′) of the narrow channel region, respectively. As shown in FIG. 7, only the height of the broad channel region 11a′ may be greater than that of the narrow channel region 11b′. More specifically, the broad channel region 11a′ may have the cross-section area in the shape of semicircle and the narrow channel region 11b′ may have the cross-section area in the shape of top-flat semicircle.

As shown in FIGS. 4A and 4B, the broad channel regions 11a of the neighboring discharge channels can be arranged diagonally or slantly to each other. More specifically, the broad channel region 11a of a certain discharge channel is adjacent to the narrow channel region 11b of other discharge channel adjacent to the certain discharge channel. Also, the narrow region 11B of a discharge channel is adjacent to the broad channel 11a of the neighboring discharge channel. In such a case, the broad channel regions of the neighboring discharge channels has the same length (L) and therefore the length (L) of the broad channel region and the length (I) of the narrow channel region is almost the same. The width of the broad channel region 11a expands toward the narrow channel region 11b of the neighboring discharge channel. Thus, the same distance is maintained between the neighboring discharge channels.

This structure mentioned above enables not only a non-emissive area 13 existing between the discharge channels to extend in zigzags along the length of the discharge channel, but also the narrow channel region 11b with relatively-high luminance to compensate or cover the low luminance of the non-emissive area 13. Thus, it is made possible to alleviate or eliminate “dark line” which arises from the non-emissive area.

The broad channel region 11a of the flat fluorescent lamp 10 according to the first embodiment of the present invention, when viewed from above, is almost in the shape of a rectangle, but may take a variety of shapes.

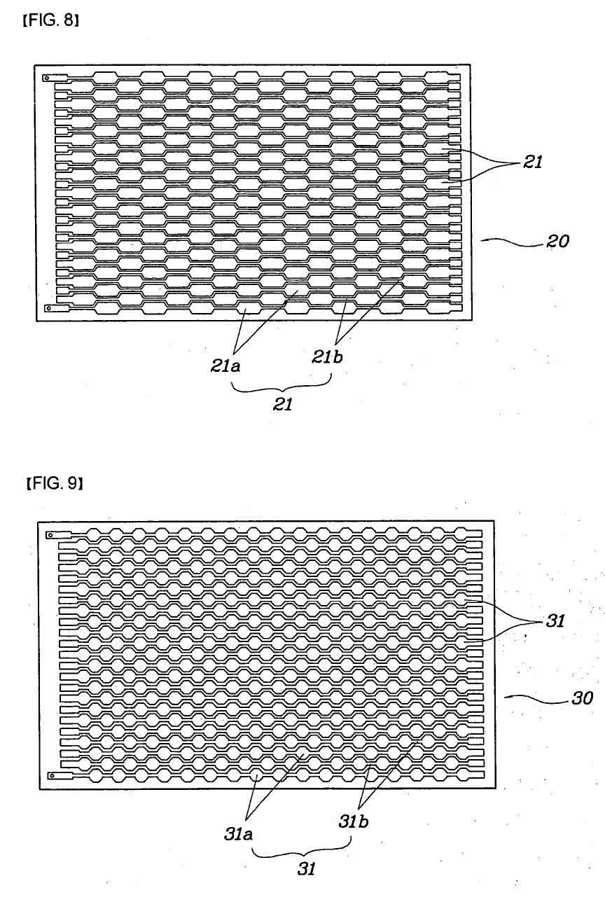

As shown in FIGS. 8 and 9, the broad channel region may take a honeycomb shape 21a or a circle-like hexagon shape 31a. The change in the shape of the broad channel region may be applied to embodiments to be described hereafter. Reference numerals 21 and 31 and reference numerals 21a and 31b refer to the discharge channels and the narrow channel regions, respectively.

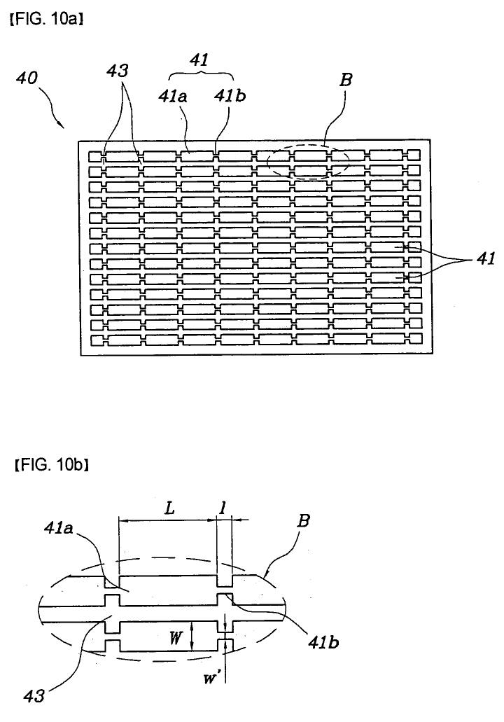

Referring to FIGS. 10A and 10B, a flat fluorescent lamp according to a second embodiment of the present invention is below described.

Unlike in the first embodiment, broad channel regions of a certain discharge channel are arranged in parallel with those of its neighboring discharge channels. More specifically, the broad channel region 41a of the certain discharge channel is adjacent to the broad channel region 41a of its neighboring discharge channels. Otherwise, the narrow channel region 41b is adjacent to the broad channel region 41a of its neighboring discharge channels. At this point, a length of the broad channel region 41a has to be greater than that of the narrow channel region 41b. If the length of the narrow channel region 41b is greater than that of the broad channel region 41a, the non-emissive area 43 existing between the discharge channels 41 becomes wider, and thus causes a dark region to occur on the non-emissive area 43. The length of the narrow channel region 41b may be in the range of a half to a twentieth of that of the broad channel region 41a.

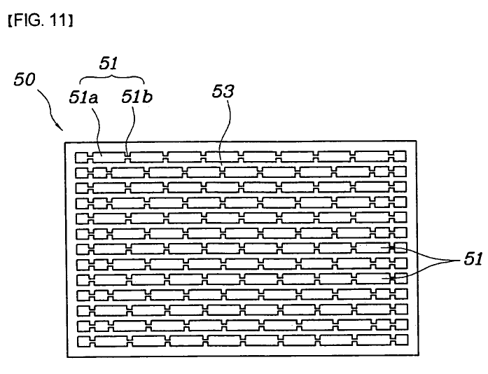

Referring to FIG. 11, a flat fluorescent lamp according to a third embodiment of the present invention is below described.

As in the first embodiment, broad channel regions 51a of neighboring discharge channels 51 may be arranged diagonally or slantly. However, unlike in the first embodiment, the length of the narrow channel region 51b is smaller than that of the broad channel region 51a, and the narrow channel regions 51b of a certain discharge channel is arranged adjacent to the center portion of each of broad channel regions of its neighboring discharge channel. The length of the narrow channel region 51b may be in the range of a half to a twentieth of that of the broad channel region 51a.

The shapes of the discharge channels illustrated in the drawings are not drawn to scale in order to serve to help understand the embodiments of the present invention. In a case where the difference in the cross-sectional area between the broad channel region and the narrow channel region is made by adjusting the height of the discharge channel, the arrangement of broad channel regions and narrow channel regions between the neighboring channels may be different from that of the second and third embodiments of the present invention.

The broad channel region with broad cross-sectional area may be provided at both ends of the discharge channel of the flat fluorescent lamp according to the present invention. This is advantageous in generating and accelerating enough electrons or electric charges in both ends of the discharge channel where electrodes are provided.

The arrangement of alternating the broad and narrow channel regions in the direction of the length of the discharge channel makes it possible not only to enhance the luminance of the flat fluorescent lamp and improve the discharge efficiency of the flat fluorescent lamp, but also to alleviate or remove the “dark line” phenomenon arising from the non-emissive area existing between the discharge channels.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. A flat fluorescent lamp comprising:
an upper substrate;
a lower substrate attached to the upper substrate; and
a plurality of discharge channels provided parallelly to each other on the upper substrate, wherein at least one of the discharge channels has alternating broad and narrow channel regions along the longitudinal direction of the discharge channel.

2. The flat fluorescent lamp according to claim 1, wherein each of the discharge channels has the broad and narrow channel regions.

3. The flat fluorescent lamp according to claim 1, wherein the broad channel region is different from the narrow channel region in height or width or both.

4. The flat fluorescent lamp according to claim 3, wherein the broad channel regions of a certain discharge channel are arranged diagonally or slantly to the broad channel regions of the discharge channels adjacent to the certain discharge channel.

5. The flat fluorescent lamp according to claim 3, wherein the broad channel regions of a certain discharge channel are arranged in parallel with the broad channel regions of the discharge channels adjacent to the certain discharge channel.

6. The flat fluorescent lamp according to claim 3, wherein the same distance is maintained between the discharge channels adjacent to each other.

7. The flat fluorescent lamp according to claim 3, wherein each of the broad channel regions has the same length.

8. The flat fluorescent lamp according to claim 3, wherein length of the broad channel region is larger than that of the narrow channel region.

9. The flat fluorescent lamp according to claim 3, wherein the narrow channel region of a certain discharge channel is arranged adjacent to the center portion of the broad channel region of the discharge channels adjacent to the certain discharge channel.

10. The flat fluorescent lamp according to claim 3, wherein the broad channel region is provided at both ends of the discharge channel.
